(19) United States
(12) Patent Application Publication
(10) Pub. No.: US 2020/0037825 A1
(43) Pub. Date: Feb. 6, 2020

(54) PRESSURE CONTROLLED FOOD PRODUCT DELIVERY APPARATUS AND METHOD OF USE THEREOF

(71) Applicants: Christian T. Metcalfe, Mercer Island, WA (US); W. Davis Lee, Rockport, ME (US)

(72) Inventors: Christian T. Metcalfe, Mercer Island, WA (US); W. Davis Lee, Rockport, ME (US)

(21) Appl. No.: 16/601,601

(22) Filed: Oct. 15, 2019

Related U.S. Application Data
(63) Continuation-in-part of application No. 15/125,434, filed on Sep. 12, 2016.
(60) Provisional application No. 61/953,160, filed on Mar. 14, 2014.
(60) Provisional application No. 62/052,376, filed on Sep. 18, 2014.

(51) Int. Cl. A47J 43/12; B65D 83/30; B65D 85/72; A23L 2/54

(52) U.S. Cl. CPC A47J 43/12; B65D 83/30; A23V 2002/00; A23L 2/54; B65D 85/72

(57) ABSTRACT

The invention comprises a method and apparatus for delivery of a product, such as whipped cream, from a pressurized container containing a deformable bladder, the deformable bladder separating a main compartment of the pressurized container into a pressure reserve zone and a pressurized delivery zone, where a membrane in the pressure reserve zone initially separates first chemical reagents from second chemical reagents. Upon a force creating an opening in the membrane, a reaction of the chemical reagents forms a gas, which alters a volume of the deformable bladder and the volume of the pressurized delivery zone with a corresponding increase in pressure of a deliverable gas in the pressure delivery zone. A resulting increased pressure of the deliverable gas, which permeates cream, maintains quality of delivered whipped cream from the pressurized container.

### CROSS-REFERENCES TO RELATED APPLICATIONS

This application is a continuation-in-part of U.S. patent application Ser. No. 15/125,434 filed Mar. 13, 2015, which claims the benefit of:

U.S. provisional patent application No. 61/953,160 filed Mar. 14 2014; and

U.S. provisional patent application No. 62/052,376 filed Sep. 18, 2014.

### BACKGROUND OF THE INVENTION

### Field of the Invention

The invention relates generally to a pressure controlled food product delivery apparatus and method of use thereof, such as a pressure controlled/adjusted whip cream delivery system.

### Discussion of the Prior Art

Patents related to the current invention are summarized here.

W. Kirsch, et. al., “Nitrous Oxide Mixtures and Methods of Use”, U.S. patent application publication no. 2017/0079478 (Mar. 23, 2017) describe delivery of a liquid substance powered by a compressed noble gas.

### Problem

There exists in the art a need for a pressure controlled system for delivery of a food substance.

### SUMMARY OF THE INVENTION

The invention comprises a pressure controlled food product delivery apparatus and method of use thereof.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1A illustrates a pressurized food substance delivery system optimized for food quality at a first time, FIG. 1B, and at a second time, FIG. 1C;

FIG. 2 illustrates a cream delivery method;

FIG. 3A and FIG. 3B illustrate a cream delivery canister assisted by a pressurized bladder and FIG. 3C illustrates quality improvement using the pressurized canister;

FIG. 4A and FIG. 4B illustrate a pressure sensitive membrane before and after opening, respectively, and FIG. 4C illustrates food product quality enhancement after membrane opening;

FIG. 5A, FIG. 5B, and FIG. 5C illustrate a canister with a pressure sensitive membrane, a pressure sensitive membrane, and product quality enhancement using a repetitive pressure adjustment, respectively;

FIG. 6A and FIG. 6B illustrate pressure adjustment using a chemical reaction and resultant quality enhancement, respectively;

FIG. 7A and FIG. 7B illustrate a potential energy assisted pressurized air delivery system at a first and second time, respectively, with a corresponding analog enhancement in quality of a delivered food, FIG. 7C; and

FIG. 8A and FIG. 8B illustrate a sealed pressure chamber at a first and second time, respectively, and FIG. 8C illustrates a corresponding food quality enhancement.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises a method and apparatus for delivery of a product, such as whipped cream, from a pressurized container containing a deformable bladder, the deformable bladder separating a main compartment of the pressurized container into a pressure reserve zone and a pressurized delivery zone, where a membrane in the pressure reserve zone initially separates first chemical reagents from second chemical reagents. Upon a force creating an opening in the membrane, a reaction of the chemical reagents forms a gas, which alters a volume of the deformable bladder and the volume of the pressurized delivery zone with a corresponding increase in pressure of a deliverable gas in the pressure delivery zone. Similarly, a spring, with or without the formed gas, is optionally used to provide a force to the deformable bladder with a corresponding increase in pressure of the deliverable gas in the pressure delivery zone. A resulting increased pressure of the deliverable gas, which permeates cream, maintains quality of delivered whipped cream from the pressurized container.

Generally, a pressurized container for delivering a product is described which uses a secondary pressure delivery assist system. The product is any aerosol, personal care produce, paint, shaving cream/gel, prescription, drug, perfume, room freshener, air freshener, food product, food constituent, and/or food substance capable of being delivered through a nozzle by a pressurized system. Herein, for clarity of presentation and without loss of generality, whipped cream is used as an example of the delivered product. More generally, the delivered product carried by any liquid, semi-liquid, foam, and/or aerosol.

### Food Product Delivery System

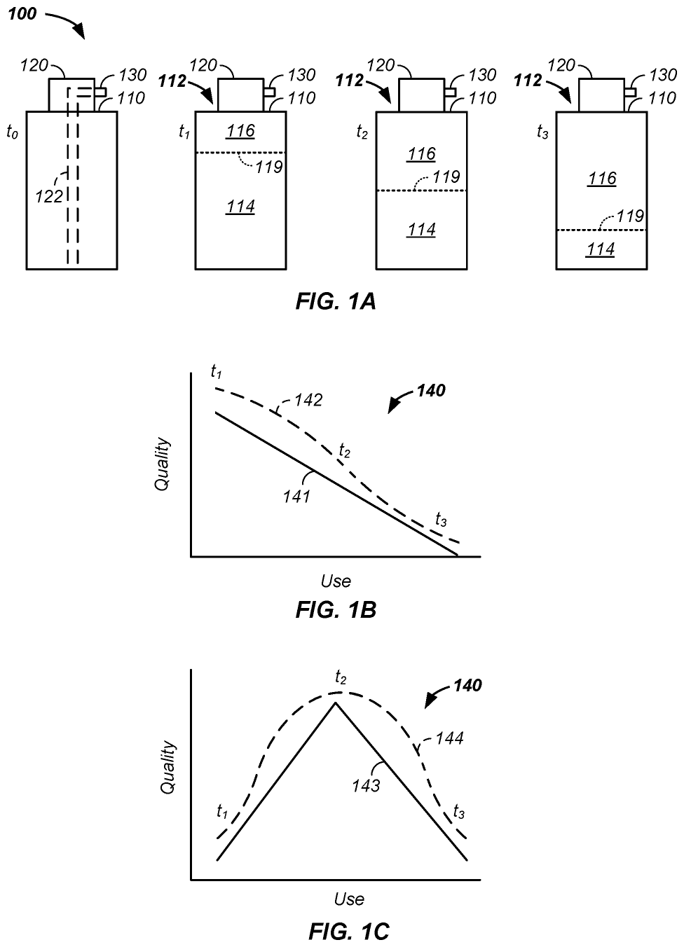

Referring now to FIG. 1A, a pressurized canister 100, also referred to as a can, used for delivery of a food substance, such as a whipped cream, is described. Herein, a product refers to the delivered whipped cream. Before filling, such as at time zero, t₀, the pressurized canister 100 comprises a main compartment 110, a delivery control system 120 or delivery control, an output nozzle 130, and optionally an internal delivery mechanism 122. The main compartment 110 comprises a pressure containment container, such as a metal and/or plastic can resembling a delivery canister for holding pressurized cream or a shaving foam/gel. The delivery control 120 comprises a button, switch, and/or lever for triggering the release of a portion of the pressurized whipped cream, such as through an operator controlled manual valve, through the output nozzle. Generally, the internal delivery mechanism 122 includes valves and/or tubes for controlling where the product is delivered from within the pressurized canister 100, which is optionally any position within the pressurized canister 100. In the illustrated example, the product is delivered from the bottom of the can or a bottom of an upper chamber of the pressurized canister 100 as the whipped cream settles to the bottom.

Still referring to FIG. 1A, contents 112 of the pressurized canister 100 are described at an initial time or first time, t₁. For whipped cream, the contents 112 comprise: a cream 114 and a deliverable compressed gas 116. While the deliverable compressed gas 116 is lighter than the cream 114 and thus sits on top of the cream 114, as represented by a liquid/air barrier 119, a portion of the compressed gas permeates the cream 114, such as through application of Henry's Law at equilibrium, equation 1,

C=Hp (eq. 1)

where C is the concentration of the compressed gas 116 in the cream 114, H is Henry's constant for the deliverable compressed gas 116 in the cream 114, and p is the partial pressure of the deliverable compressed gas 116 over the cream 114. When the delivery control is operated, the portion of the compressed gas in the cream dispensed with the cream expands within the fat molecules of the cream yielding an expanded volume of whipped cream, such as greater than 2, 3, or 4 times the original volume of cream.

Still referring to FIG. 1A, after release of a first portion of the product, such as at a second time, t₂, the volume of the cream 114 in the pressurized canister 100 has decreased. Resultant from the decreased volume of the cream 144, the volume of the deliverable compressed gas 116 has increased. Due to loss of a portion of the deliverable compressed gas 116 in the delivered product and the increased volume of the deliverable compressed gas 116, the pressure of the remaining deliverable compressed gas 116 has reduced, such as calculated by an application of the ideal gas law, equation 2,

PV=nRT (eq. 2)

where P is pressure, V is volume, n is the number of moles of gas, R is the ideal gas constant, and T is the temperature of the gas.

Referring still to FIG. 1A and now FIG. 1B and FIG. 1C, the quality of the product is dependent upon concentration of the deliverable compressed gas 116 in the cream. Thus, as the volume occupied by the cream 114 decreases and the volume of the deliverable compressed gas 116 increases, the resultant decreased concentration of the deliverable compressed gas 116, such as calculated by the ideal gas law, results in less compressed gas in the cream 114, such as calculated by Henry's law. Thus, the quality of the product decreases with time if the initial concentration of the deliverable compressed gas 116 was optimized for the initial product quality, such as illustrated in FIG. 1B in a first representative quality curve 141 and in a second representative quality curve 142, or the quality of the product increases with time and then diminishes if the initial concentration of the deliverable compressed gas 116 was optimized for quality after an initial amount of the cream 114 is delivered as product, such as illustrated in FIG. 1C in a third representative quality curve 143 and a fourth representative quality curve 144.

Referring still to FIG. 1A, FIG. 1B, and FIG. 1C, at a third time, t₃, such as after a time period corresponding with a peak concentration of the compressed gas, the volume of the cream 114 reduces further, the volume of the deliverable compressed gas 116 increases further, the concentration of the compressed gas in the remaining cream decreases further, and the quality of the product decreases further. A reserve pressure or secondary pressure is used to overcome the reduction in quality of the product with time, as further described infra.

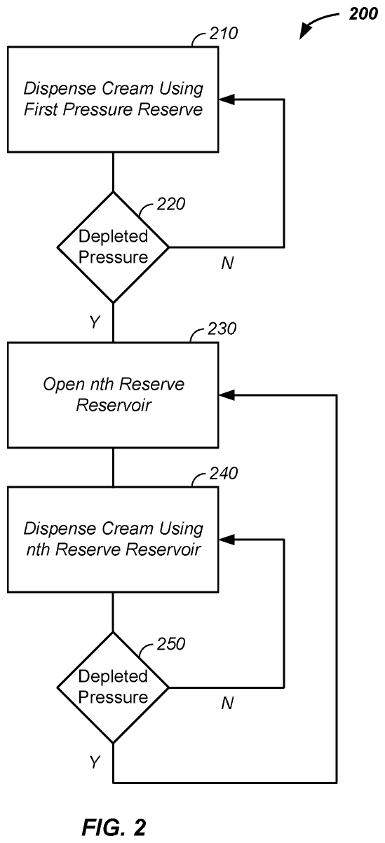

Referring now to FIG. 2, a pressure controlled delivery system 200 is described. Initially, cream is dispensed using a first pressure reserve 210, such as described for FIG. 1. During use of the pressurized canister 100, pressure is depleted 220 until a second pressure reserve 230 is activated. Subsequently, the cream is dispensed using the first pressure reserve 210 and/or the second pressure reserve 230, which results in additional depleted pressure 250. The process of opening up n pressure reserves is optionally repeated n times, where n is a positive integer of 1, 2, 3, 4, or more. Optionally, the pressure reserve is any potential energy reserve. The pressure controlled delivery system 200 is further described, infra.

### Example I

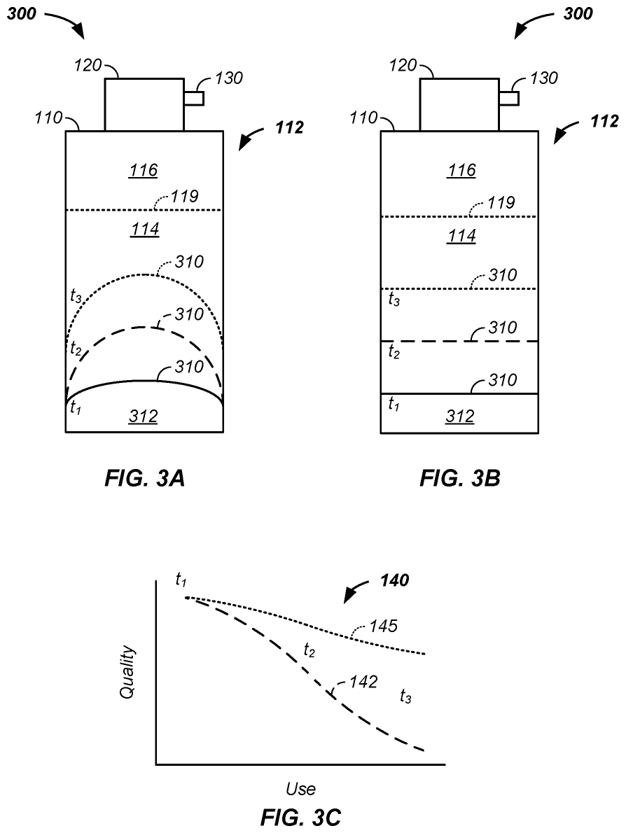

Referring now to FIG. 3A, a first example of the pressure controlled delivery system 200 is illustrated, which uses a bladder pressure system 300. The bladder pressure system 300 includes a bladder 310 inside the main compartment 110 of the pressurized canister 100. Inside the bladder 310, a pressure reserve 312 is maintained, which supplements the pressure of the deliverable compressed gas 116. As illustrated, the bladder 310 expands with time, such as at the illustrated first time, t₁, second time, t₂, and third time, t₃, as the pressure of the deliverable compress gas 116 decreases with use and as the cream is dispensed. Referring now to FIG. 3B, for clarity of presentation, the bladder 310 is illustrated with a horizontal zone divider that corresponds with the three times illustrated in FIG. 3A. Referring now to FIG. 3C, in a quality response curve 140, a fifth representative quality curve 145 shows an increased quality of the delivered cream as a function of time/use compared to the bladderless pressurized canister 100.

### Example II

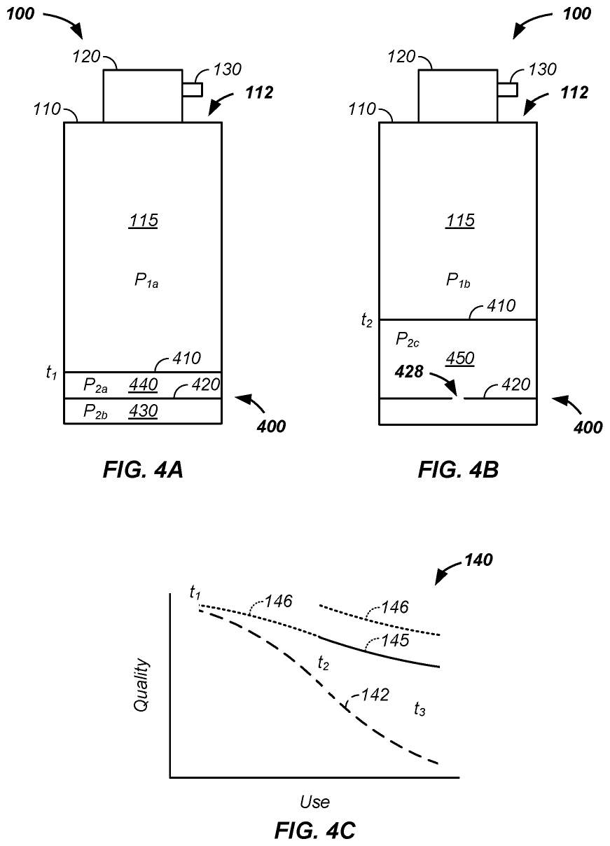

Referring now to FIG. 4A, a second example of the pressurized canister 100 is provided that includes a system using a first pressure zone and a second pressure zone, where the second pressure zone is initially separated into two containers 400. As illustrated, a deformable bladder 410, which is an example of the bladder 310, separates one or more of the internal pressure reserve 312 and a chemical pressure reserve, contained in a bladder or the deformable bladder 410, from a product delivery zone 115, where the product delivery zone 115 includes both: the cream 114 and the volume of the deliverable compressed gas 116. The deformable bladder is made of any airtight and/or water tight material, such as a polymer or a mylar in a form such as a sealed bag. More particularly, the deformable bladder 410 includes two containers 400: a first container 430 and a second container 440 separated by a membrane 420. Hence, the deformable bladder 410 separates the contents 112 of the pressurized canister 100 into a first pressure zone, P₁, and a second pressure zone, P₂.

Referring still to FIG. 4 A and referring now to FIG. 4B, the membrane 420 is optionally and preferably pressure sensitive and forms a gap 428 or rupture when a first pressure, P₁ₐ, from the cream 114 and the deliverable compressed gas 116 falls below a threshold. When the gap 428 forms, contents of the first container 430 and the second container 440 mix and chemically react to form one or more products that include a gas or a reserve pressure gas in a now unified container 450 of the first container 430 and the second container 440. Stated again, when a pressure in the product delivery zone 115 falls below a threshold, with a corresponding reduction in product quality, the membrane 420 ruptures and a reaction results through a mixture of reactants in the first container 430 with reactants in the second container 440 that forms a reserve pressure gas that pushes against the deformable bladder 410, which: (1) reduces volume of the product delivery zone 115, (2) increases pressure of the deliverable compressed gas 116, and (3) maintains the quality of the delivered cream. Referring now to FIG. 4C, when the membrane 420 ruptures at a second time, t₂, the resultant gas formation in the second pressure zone, P₂, indirectly increases pressure in the first pressure zone, P₁, and enhances product quality, as illustrated with the sixth representative quality curve 146.

### Example III

Still referring to FIGS. 4(A-C), an example of the chemical reaction occurring after the rupture of the membrane 420 in the deformable bladder 410 is provided. Initially, the deformable bladder 410 contains first reagents 432 at a first concentration, [R₁]ᵢₙᵢₜ, in the first container 430 and second reagents 434 at an initial concentration, [R₂]ᵢₙᵢₜ, in the second container 440, with corresponding initials pressures, P₂ₐ and P₂ₐ. Without loss of generality and for clarity of presentation, an exemplary reaction is provided that forms a gas. Particularly, baking soda or sodium bicarbonate reacts with vinegar or acetic acid to form sodium acetate and carbonic acid, which decomposes into carbon dioxide and water, such as in equations 3 and 4, where the formed gas is carbon dioxide.

Na⁺HCO₃⁻+CH₃COOH→Na⁺CH₃COO⁻+H₂CO₃ (eq. 3)

H₂CO₃→CO₂+H₂O (eq. 4)

The formed carbon dioxide gas increases pressure in the second pressure zone, P₂, which expands the deformable bladder 410 into the first pressure zone, P₁, and increases pressure of the deliverable compressed gas 116. The increases pressure of the deliverable gas 116, such as a nitrous oxide, permeates into the cream and delivers an enhanced/maintained product quality with time/use, as illustrated in the sixth representative quality curve 146.

### Example IV

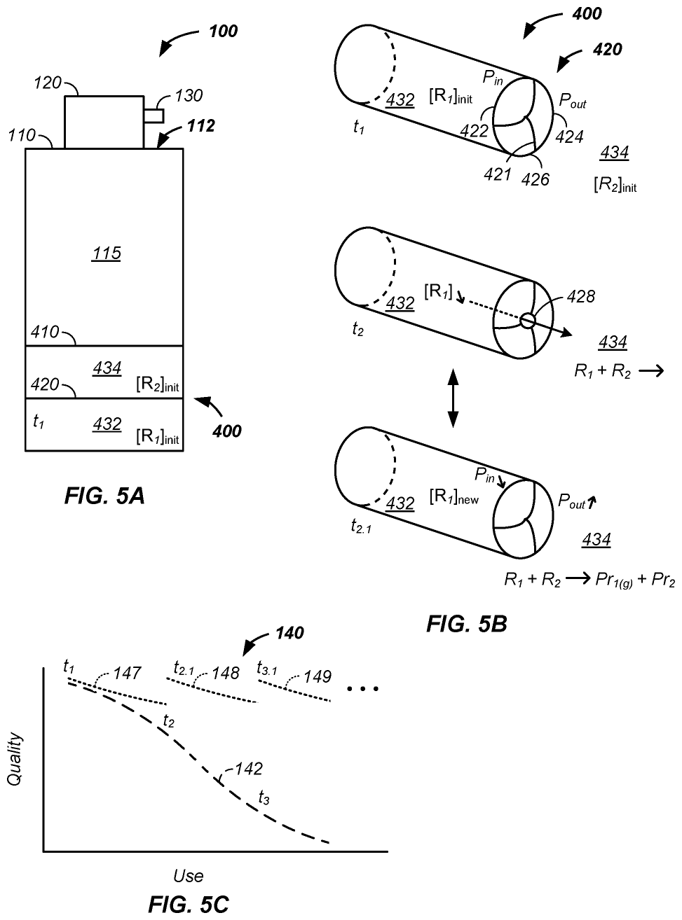

Referring now to FIG. 5A and FIG. 5B, an example of the membrane 420 is provided. Generally, the membrane 420 is any mechanical structure that separates and/or forms one or more holes, sufficient in size for at least one of the reagents in the first container 430 and/or second container 440 to pass through, as a result of an applied force. For example, the membrane 420 is optionally perforated, thinner along one of more lines or curves, made of a weaker material along a joint 421, and/or is pretreated, such as with a laser, making a weakness along the joint 421, where the joint 421 is optionally a set of joints separating and/or partially dividing a set of n membrane sections, such as a first membrane section 422, a second membrane section 424, and a third membrane section 426, where n is a positive integer of an least 2, 3, 4, 5, 10, or 15. For instance, the deformable bladder 410 expands as the pressure of the deliverable compressed gas 116 decreases, which applies a stress, strain, and/or force on the joint 421, such as a perforated joint, in the membrane causing the membrane to at least temporarily rupture forming a gap 428, a hole, and/or a tear through the membrane 420. Forces on the joint 421 are: (1) changes in pressure in the product delivery zone 115 and/or the deliverable compressed gas 116; (2) an applied force to the membrane, such as through a deployable rod connected to a user actuator; (3) heating; (4) shaking the pressurized canister 100 by a user; and/or (5) rapping of the pressurized canister against a hard surface, such as a counter, by the user. Upon formation of the gap 428, the first reagents 432 at a first concentration, [R₁]ᵢₙᵢₜ, in the first container 430 mix with the second reagents 434 at an initial concentration, [R₂]ᵢₙᵢₜ, in the second container 440, which results in the chemical formation of a gas product, Pr_{1(g)}, as described supra.

Referring now additionally to FIG. 5C, if the tear or gap 428 forms at a second time, t₂, then as illustrated the quality of the product or cream increases shortly thereafter, such as at a later time, t₂₁, as a result of the subsequent reaction forming a gas, which further inflates the deformable bladder 410 applying additional pressure on the product delivery zone 115 and deliverable compressed gas 116 therein, which in turn permeates the cream 114 and is delivered with enhanced quality, as described supra. Optionally, the membrane 420 is designed to reseal, resultant from: (1) the change in pressure and/or change in relative pressure in the first container 430, the second container 440, and/or the unified container 450 and/or (2) valve-like forces inherent in the n membrane sections, such as chemical and physical forces involved in membrane sections spontaneously returning to a lowest energy state after the gap 428 or rupture forms, which functions to reseal the membrane 420, which is referred to as a valve when resealing. As the membrane 420 or valve reseals, the flow of reagents between the first container 430 and the second container 440 ceases until the membrane 420 is again stretched to a point of reforming the gap 428. As illustrated in FIG. 5C, the process of forming the gap 428, reacting reagents to form a gas with the resultant enhancement of product quality, and closing the valve optionally repeats n times, where n is a positive integer of 2, 3, 4, 5, 10, 15 or more to yield n enhancements of quality, such as respectively illustrated in the seventh, eighth, and ninth quality curves, 147, 148, 149.

### Example V

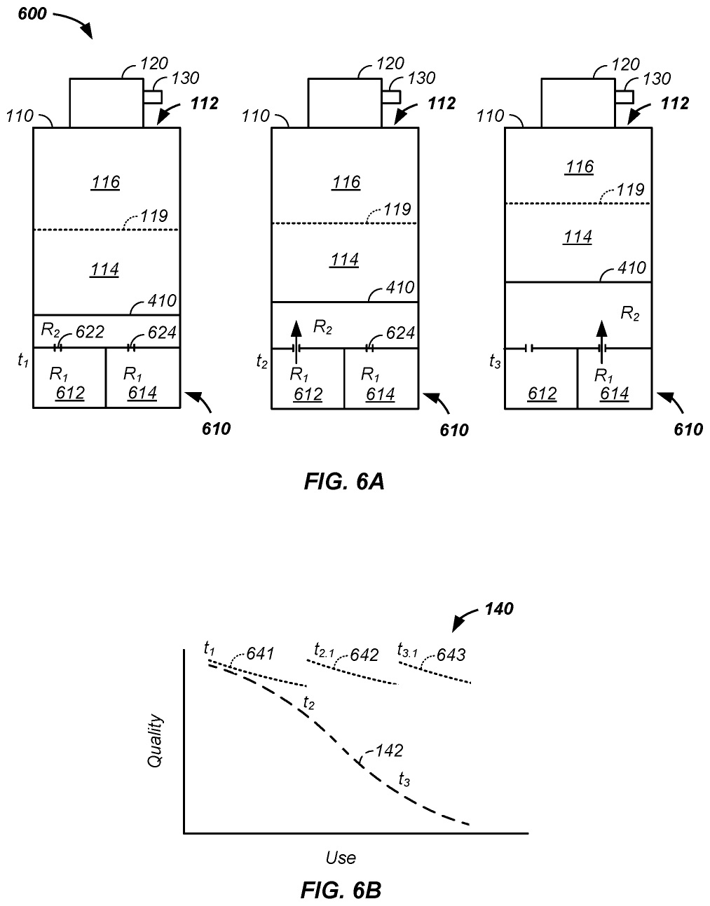

Referring now to FIG. 6A, an example of a multiple pressure reserve system 600 is provided. As illustrated, the multiple pressure reserve system 600 uses a first reserve compartment 612 associated with a first gap forming membrane 622 and a second reserve compartment 614 associated with a second gap forming membrane 624, where the first and second gap forming membranes 622, 624 have differing physical properties, such as those described for the membrane 420 and open respectively gaps, tears, or ruptures along weakness sections, points, lines, or arcs, such as the joints 421, such as under differing physical conditions/forces like the above described forces applied to the joints 421. For instance, the first gap forming membrane 622 opens at a second time, t₂, resultant in mixing first reagents in the first reserve compartment 612 with second reagents to form a gas, such as described in the baking soda and vinegar reaction and the second gap forming membrane 624 opens at a third time, t₃, resultant in mixing first reagents in the second reserve compartment 614 with second reagents to form more of the gas. As a result, the pressure of the deliverable compressed gas 116 increases after each gap opening as the formed gas pushes against the deformable bladder 410 with corresponding enhancements in the quality curve, such as the respective tenth, eleventh, twelfth quality curves 641, 642, 642 illustrated in FIG. 6B. Generally, the pressurized canister 100 contains any number of compartments, such as 1, 2, 3, 4, or more.

### Example VI

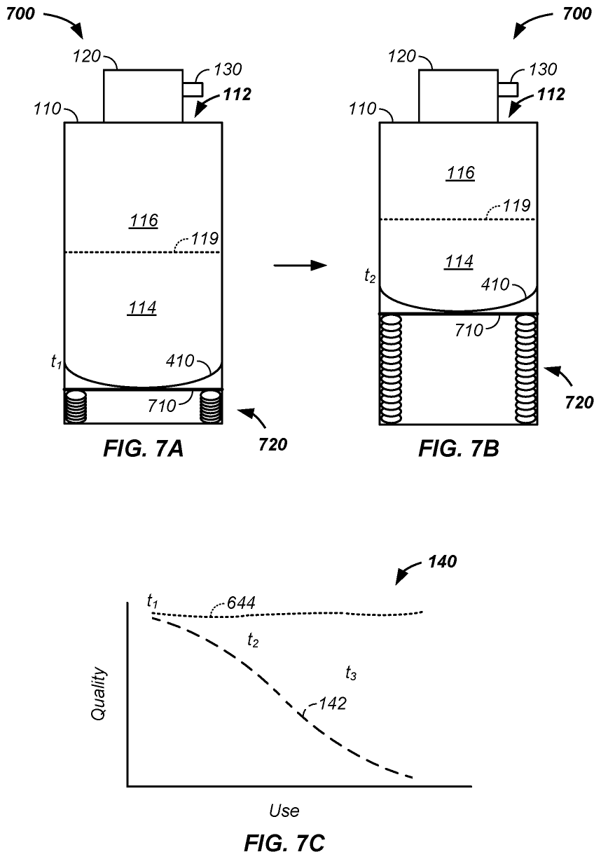

Referring now to FIG. 7A and FIG. 7B, a spring force pressure system 700 is provided. As illustrated, a set of one or more springs 720 apply a force against a pressure plate 710, which transfers the spring force to the deformable bladder 410. In this case, the deformable bladder 410 is illustrated as containing both the cream 114 and the deliverable compressed gas 116. As described above, as the deformable bladder shrinks the volume of the product delivery zone 115 and the pressure of the deliverable compressed gas 116 increases. In practice, the spring constant of the set of springs 720 compensates for the loss of pressure of the deliverable compressed gas 116 with use resultant in an analog varying and consistently high quality of the product as illustrated in the thirteenth quality response curve 644, FIG. 7C. Optionally, the set of springs 720 act directly on the deformable bladder 410 without presence of the pressure plate 710.

### Example VII

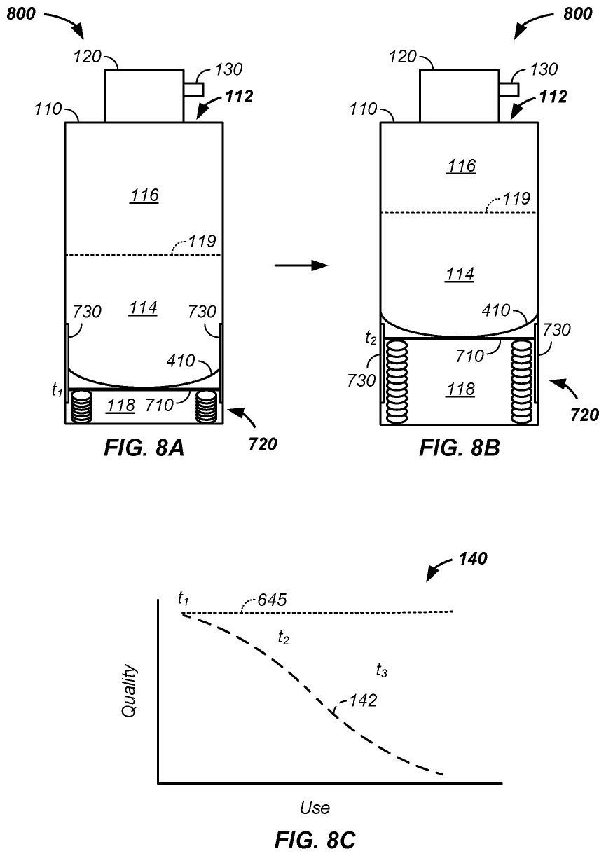

Referring now to FIG. 8A and FIG. 8B, the spring force pressure system 700 is optionally supplemented with a guide 730 to form a pressure plate system 800. The guide 730 is any mechanical device or system that constrains movement of the pressure plate 710, such as along a z-axis of the main compartment 710, such as a set of guide rails 730 and/or pressure seals. Optionally, the main compartment contains a supplemental pressurized gas in a supplemental pressure zone 118 outside of the deformable bladder 410, which reduces the needed concentration of the deliverable compressed gas 116 as the supplemental pressurized gas provides a product delivery force and the deliverable pressurized gas 116 need only be sufficient to inflate the cream. Reduction in the concentration of the deliverable pressurized gas 116 is beneficial as a typical pressurized gas is nitrous oxide, which is used as a recreational gas to create a calm feeling and/or a euphoric feeling. The set of springs 720 and/or the supplemental pressurized gas in the supplemental pressure zone 118 result in a fourteenth quality response curve 645, which is analog in nature.

Notably, the supplemental pressurized gas in the supplemental pressure zone 118 is optionally used without the set of springs 720 and/or without use of the gas forming reaction mechanism. Similarly, the gas forming system is optionally used external to the deformable bladder 410 when the deformable bladder contains the cream and deliverable compressed gas. Further, the deliverable compressed gas is optionally a mix of gasses, where the mix of gasses contains less than 50, 25, 10, 5, or 1 percent nitrous oxide or no nitrous oxide at all.

Notably, the bladder and/or pressure reserve system described herein is optionally used to deliver any product from a pressurized canister using any propellant, such as nitrogen gas or isobutane. Further, while nitrogen gas is used as an example propellant herein, nitrogen gas is representative of any propellant and/or mix of propellants.

The pressure reserve system used herein allows delivery of a product from a canister at a lower initial pressure, which allows for a canister made up of a thinner and/or a weaker material. For example, the metal canister thickness may be reduced by greater than 10, 20, 30, 40, or 50 percent.

Still yet another embodiment includes any combination and/or permutation of any of the elements described herein.

Herein, any number, such as 1, 2, 3, 4, 5, is optionally more than the number, less than the number, or within 1, 2, 5, 10, 20, or 50 percent of the number.

Herein, an element and/or object is optionally manually and/or mechanically moved, such as along a guiding element, with a motor, and/or under control of a main controller.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. An apparatus for delivering a product, comprising:
a pressurized container, comprising:
a main compartment;
a delivery control system;
an output nozzle, said delivery control system controlling flow of the cream from said main compartment through said output nozzle; and
a deformable bladder separating a pressure reserve zone inside said main compartment from a pressurized delivery zone inside said main compartment.

2. The apparatus of claim 1, said pressure reserve zone further comprising:
a membrane separating first chemical reagents from second chemical reagents.

3. The apparatus of claim 2, said membrane further comprising:
a first set of areas of a first mechanical strength; and
a second separation zone of a second mechanical strength, said separation zone configured to, responsive to an applied force, at least temporarily form a gap between a first area of said first mechanical strength from a second area of said first mechanical strength resultant in mixing said first chemical reagents with said second chemical reagents to form at least a gas, said gas expanding a volume of said deformable bladder.

4. The apparatus of claim 3, said pressurized delivery zone configured to hold:
a cream; and
a deliverable pressurized gas, at least a portion of said deliverable pressurized gas permeated in said cream.

5. The apparatus of claim 4, said membrane comprising an outer perimeter affixed to an inner wall of said deformable bladder.

6. The apparatus of claim 5, said separation zone of said membrane responsive to a mechanical stretching of said deformable bladder to form said gap.

7. The apparatus of claim 4, said membrane further comprising a first thickness of a flexible sheet of a material, said separation zone comprising a second thickness of said material, said first thickness at least two times said second thickness.

8. The apparatus of claim 4, said separation zone comprising a set of weakened points along at least one of:
a line;
a curve;
a portion of an edge of said gap; and
a portion of a perimeter of said gap.

9. The apparatus of claim 8, said set of weakened points comprising a series of laser weakened positions.

10. The apparatus of claim 1, said deformable bladder further containing: a first pressure reserve container and a second pressure reserve container.

11. The apparatus of claim 1, said pressurized container further comprising:
at least one spring configured to apply a spring force pressure to said deformable bladder.

12. A method for delivering a product, comprising the steps of:
a pressurized container containing a deformable bladder, said pressurized container further comprising:
a main compartment;
a delivery control system; and
an output nozzle;
said deformable bladder separating a pressure reserve zone inside said main compartment from a pressurized delivery zone inside said main compartment; and
said delivery control system mechanically controlling an opening allowing flow of the cream from said main compartment through said output nozzle.

13. The method of claim 12, further comprising the step of:
a membrane separating first chemical reagents from second chemical reagents, said membrane positioned within said pressure reserve zone.

14. The method of claim 13, further comprising the steps of:
applying a force to said membrane, said membrane comprising:
a set of areas of a first mechanical strength; and
a second separation zone of a second mechanical strength;
said force, at least temporarily, forming a gap between a first area of said set of areas of said first mechanical strength and a second area of said set of areas of said first mechanical strength resultant in mixing said first chemical reagents with said second chemical reagents to form at least a gas; and
said gas expanding a volume of said deformable bladder.

15. The method of claim 13, further comprising the step of:
said gap forming a permanent tear between two points of said membrane.

16. The method of claim 15, further comprising the step of:
mechanical memory of said membrane, at least temporarily, resealing said gap preventing further mixture of said first reagents remaining on a first side of said membrane from mixing with said second reagents remaining on a second side of said membrane.

17. The method of claim 14, further comprising the steps of:
said gas altering a first volume of said deformable bladder;
said step of altering the first volume of said deformable bladder altering a second volume of said pressurized delivery zone and increasing a pressure internal to said pressurized delivery zone.

18. The method of claim 12, further comprising the step of:
after delivery of at least twenty-five percent of said product from said pressurized container, activating a reserve force in said pressure reserve zone to alter pressure of a deliverable gas in said pressurized delivery zone.

19. The method of claim 18, further comprising the step of:
delivering a gas maintained in said pressurized delivery zone in said cream to form a delivered whipped cream.

20. The method of claim 12, further comprising the step of:
applying a spring force to said deformable bladder to at least partially compensate for loss of pressure in said pressurized delivery zone with dispensing of the product.
